(19) United States
(12) Patent Application Publication
(10) Pub. No.: US 2016/0153365 A1
(43) Pub. Date: Jun. 2, 2016

(54) Method of Operation of a Gas Turbine Engine

(71) Applicant: ROLLS-ROYCE plc, London (GB)

(72) Inventors: Paul FLETCHER, Rugby (GB); Malcolm Laurence HILLEL, Derby (GB); Philip Patrick WALSH, Solihull (GB)

(73) Assignee: ROLLS-ROYCE plc, London (GB)

(21) Appl. No.: 14/815,207

(22) Filed: Jul. 31, 2015

(30) Foreign Application Priority Data
Aug. 19, 2014 (GB) 1414662.5

(51) Int. Cl. F02C 9/32; F02C 9/54; F02C 9/18; F02C 3/13; F02C 7/22

(52) U.S. Cl. CPC F02C 9/32; F02C 3/13; F02C 7/222; F02C 9/18; F02C 9/54; F05D 2220/32; F05D 2240/35

(57) ABSTRACT

A method of operating a gas turbine engine (20) comprising a variable geometry compressor (24), a variable geometry combustor (28), and a variable geometry turbine (30). The method comprises operating the variable geometry combustor (28) such that a corrected flow ωc through a combustion zone (46, 48) of the combustor (28) matches a predetermined value.

### FIELD OF THE INVENTION

The present invention relates to a gas turbine engine, a combustor for a gas turbine engine, and methods of operation of a gas turbine engine.

### BACKGROUND TO THE INVENTION

FIG. 1 shows a gas turbine engine 10 for use as an APU for an aircraft (not shown). The engine 10 comprises, in axial flow series, an air intake duct 11, a gas turbine compressor 12, a combustor 13, a high pressure turbine 14, a low pressure turbine 15, and a load compressor 16. The compressors 12, 16 and turbines 14, 15 are coupled by a shaft 17, and all rotate about the major axis of the gas turbine engine 10 and so define the axial direction of the gas turbine engine 10. Air is fed from the air intake duct 11 to the compressors 12, 16. Compressed air from the gas turbine compressor 12 is fed to the combustor 13, where it is mixed with fuel and burnt. The hot combustion gasses flow through and drive the turbines 14, 15, which in turn drive the compressors 12, 16. Compressed air from the load compressor 16 is used to start main engines (not shown) of the aircraft, or to provide cabin pressurisation. An electrical generator (not shown) may also be driven by the turbines 14, 15, for providing electrical power to the aircraft when the main engines are not started. Such engines may also be used to drive aircraft propellers, having either a fixed pitch (and so variable rotational speed), or variable pitch (and so substantially constant rotational speed). In such cases, the load compressor 16 would be omitted, and replaced by a suitable propeller and reduction gearbox. Other variants may omit the separate load compressor, and use a single gas turbine compressor to deliver compressed air both to the combustor and the aircraft main engine for starting. In other cases, the load compressor could be substituted for an electrical generator.

Conventional gas turbine engines such as engine 10 may be arranged to have variable power output. To vary the power output, the flow rate of fuel in the combustor 13 is varied, which accelerates or decelerates the engine (i.e. increases or reduces the rotational speed of the compressors 12, 16 and turbines 14, 15), thus adjusting the engine power output, and therefore the torque provided to the load. Such engines 10 have a variable cycle, in that the Overall Pressure Ratio (OPR) and turbine inlet temperature (T4) vary in accordance with power output, as the engine is accelerated and decelerated. As a result of the variable cycle, such engines are relatively inefficient at low power, since the resultant relatively low OPR and T4 result in low thermodynamic efficiency.

Gas turbine engines have been proposed which have a substantially constant cycle, such that at least one of OPR and T4 are kept substantially constant at varying engine power levels by varying mass flow (w) through the engine core, thereby maintaining engine efficiency over a larger range of engine powers.

One such design is disclosed in U.S. Pat. No. 3,899,886, which discloses a gas turbine engine having a centrifugal compressor driven by a centrifugal turbine. The compressor has a variable geometry, comprising variable inlet and diffuser vanes. The turbine also has a variable geometry, comprising a variable inlet guide vane. The combustor comprises a combustion liner within a combustor can, the liner comprising a plurality of dilution ports. A valve arrangement is provided, which controls the amount of dilution air entering the dilution zone of the combustor from the can. However, the valves operate in a relatively hot, high pressure area of the gas turbine engine (the combustor can), thereby resulting in a design which is difficult to achieve, in view of difficulties in sealing the valve stems and ensuring adequate life of the components.

US patent application US 20050095542 discloses a further variable geometry combustor. Again, a valve arrangement is provided which modulates air entering the dilution zone of the combustor. Again however, the valves must operate in a high temperature environment, and therefore suffers the same disadvantages of the combustor of U.S. Pat. No. 3,899,886.

Control of constant cycle engines can be difficult, given the large number of control variables and constraints. For example, the compressor must be operated within a pressure range such that it does not stall or surge under any operating conditions. Compressor, combustor and turbine temperatures must also be kept to within predetermined limits to ensure acceptable longevity of components. These pressures and temperatures are interrelated, with changes in temperature and pressure of one component affecting temperatures and pressures of downstream components. Where the engine is used to drive a fixed pitch propeller or electrical generator, engine rotational speed must be kept substantially constant at varying engine loads in order to match propeller or generator operating constraints such as propeller efficiency and electrical generator frequency output. Where the gas turbine engine compressor is used to supply compressor air for engine starting, the compressor delivery temperature and pressure must be kept within predetermined limits. These constraints must be met while operating the engine as efficiently as possible, to reduce operating costs.

The present invention describes a gas turbine engine and a method of operating a gas turbine engine which seeks to overcome some or all of the above problems.

### SUMMARY OF THE INVENTION

According to a first aspect of the present invention, there is provided a gas turbine engine comprising:

a variable geometry engine compressor;
a variable geometry engine turbine coupled to the engine compressor; and
a combustor having an inlet arranged to receive air from a first engine compressor outlet, and an outlet arranged to deliver combustion products to the engine turbine;
a combustor bypass passage having an inlet arranged to receive air from a second engine compressor outlet , and an outlet in fluid communication with a main fluid flow path downstream of a combustion zone of the combustor and upstream of an engine turbine inlet; wherein
the combustor bypass passage comprises a bypass control valve configured to selectively modulate the ratio of air flowing to the combustor inlet to air flowing through the bypass passage.

Accordingly, the present disclosure provides a gas turbine engine which effectively has a variable geometry compressor, turbine and combustor, thereby permitting substantially constant cycle operation. The combustor is capable of varying its capacity without the requirement for valves which operate in high temperature zones, thereby providing good longevity for the valves. Since the airflow through the combustor can be controlled independently of the airflow through the compressor, the air/fuel ratio can easily be maintained. The engine is highly flexible, and can be operated in accordance with different operating methods in order to accommodate differing needs.

The variable geometry engine compressor may comprise a centrifugal compressor. The engine compressor may comprise a variable inlet guide vane configured to vary an inlet area of the engine compressor, and may comprise a variable diffuser guide vane configured to vary an outlet area of the engine compressor.

The variable geometry engine turbine may comprise an axial turbine. The variable geometry turbine may comprise a variable area nozzle guide vane configured to vary an inlet area of the variable geometry engine turbine.

The gas turbine engine may comprise a heat exchanger configured to heat compressor outlet air prior to combustion using heat from turbine outlet air. The heat exchanger may comprise a recuperator or a regenerator. A recuperator has been found to be particularly advantageous in the present arrangement, since variable geometry compressors and turbines may be relatively inefficient when operated at low area positions (i.e. at low power). Consequently, the exhaust gas temperature can be expected to be relatively high, and the compressor exit temperature can be expected to be relatively low. By providing a recuperator, this otherwise wasted heat at low power settings can be recovered, therefore improving thermal efficiency at low power settings.

The gas turbine engine may comprise a bleed duct in fluid communication with an outlet of the variable geometry engine compressor. The bleed duct may comprise a valve configured to modulate air flow through the bleed duct. Advantageously, the combination of a variable geometry compressor, variable geometry combustor and variable geometry turbine, enables the engine compressor to be utilised to provide a large quantity of bleed air, while satisfying compressor operability requirements. Consequently, a separate load compressor for engine starting and ECS operation may not be required, which thereby saves weight.

The combustor may comprise a combustor liner and a combustor casing. The bypass control valve may be located in a region of the bypass passage outside of the combustor casing. The combustor may comprise a single combustor can. The gas turbine engine may comprise a scroll located between the combustor outlet and the turbine inlet. Advantageously, the scroll provides a swirl to air entering the turbine inlet, which allows the nozzle guide vane to have a relatively straight aerofoil profile. Consequently, a variable inlet guide can be more readily provided, which may have a relatively small camber.

The combustor may comprise at least one dilution port. The combustor may comprise a first set of dilution ports and a second set of dilution ports. The first set of dilution ports may be configured to admit air to a combustion zone within the interior of the combustor liner from the combustor casing. The second set of dilution ports may be configured to admit dilution air from the bypass duct to a non-combustion zone within the interior of the combustor liner. The combustor may comprise further sets of dilution ports.

The gas turbine engine may comprise a load comprising one or more of a further compressor, a gearbox and an electrical generator. The electrical generator may comprise an alternating current electrical generator.

According to a second aspect of the present invention, there is provided a method of operating a gas turbine engine in accordance with the first aspect of the invention, the method comprising;

operating the bypass control valve such that a corrected mass flow ω_{c} through a combustor combustion zone matches a predetermined value.

The above method of operation ensures that substantially constant discharge conditions can be provided to the turbine inlet in a gas turbine engine having a variable compressor, a variable combustor and a variable turbine.

According to a third aspect of the present invention, there is provided a method of operating a gas turbine engine comprising a variable geometry compressor, a variable geometry combustor, and a variable geometry turbine, the method comprising:

operating the variable geometry combustor such that a corrected flow ω_{c} through a combustion zone of the combustor matches a predetermined value.

The method may comprise varying fuel flow to the combustor such that a turbine rotational speed matches a predetermined value. The predetermined turbine rotational speed may comprise a fixed value, or may be determined based on a required speed signal.

The method may comprise varying the mass flow of the variable geometry compressor such that the compressor pressure ratio matches a predetermined value.

The predetermined pressure ratio may be determined in accordance with a schedule of corrected compressor rotational speed.

The schedule of corrected compressor rotational speed may be determined to obtain a maximum compressor ratio which results in stable compressor operation. Alternatively, the schedule of corrected compressor rotational speed may be determined to obtain a compressor ratio which results in both stable compressor operation and maximum compressor efficiency.

The schedule of corrected compressor rotational speed may be determined to obtain at least a minimum bleed air pressure, and may be determined to obtain at most a maximum bleed air temperature.

The method may comprise operating the variable geometry first turbine such that the engine turbine inlet temperature T4 matches a predetermined value.

### BRIEF DESCRIPTION OF THE DRAWINGS

FIG. 1 shows a schematic cross sectional view of a prior gas turbine engine;

FIG. 2 shows a schematic diagram of a first gas turbine engine in accordance with the present disclosure;

FIG. 3 shows a schematic cross sectional view of part of the gas turbine engine of FIG. 2; and

FIG. 4 is a flow diagram illustrating a first method of controlling the engine of FIG. 2

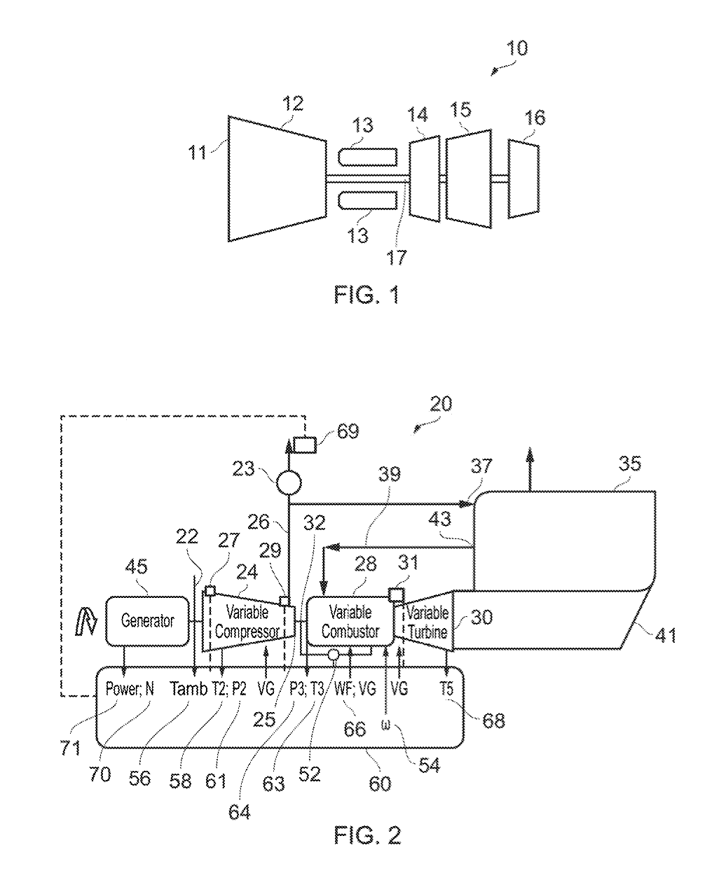

### DETAILED DESCRIPTION

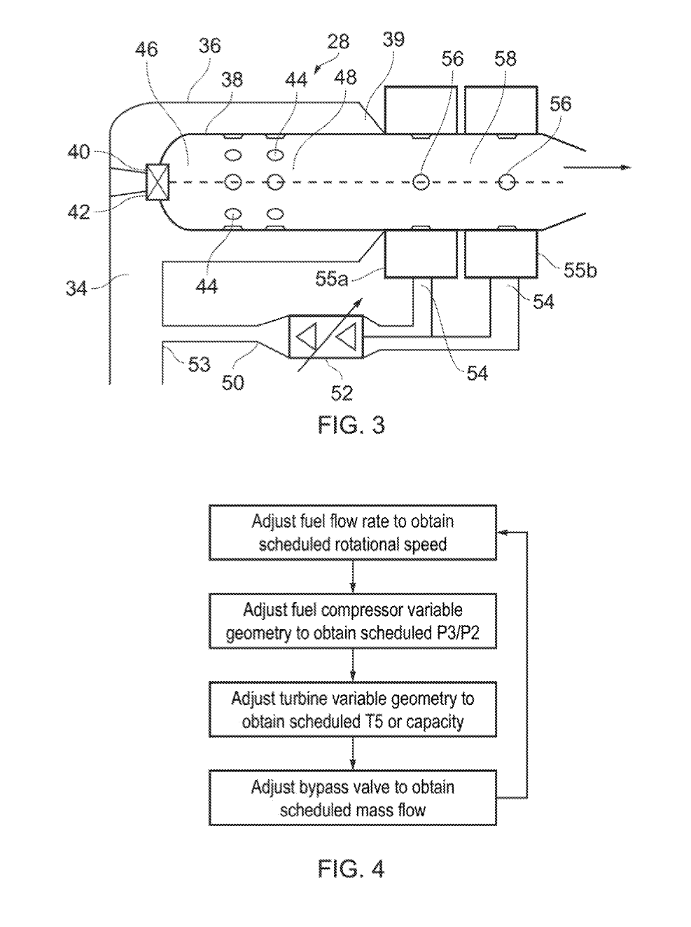

FIGS. 2 and 3 show a gas turbine engine 20 in accordance with the present disclosure. FIG. 2 shows the components and their interrelationships, and does not necessarily reflect the physical appearance of the engine 20. The engine 20 comprises an inlet 22, which feeds ambient air to a variable geometry compressor 24. An optional compressor bleed 26 is provided downstream of the compressor 24, which takes compressed air from the compressor 24, and delivers this air to an aircraft main engine and/or an aircraft environmental control system for example. The bleed flow is controlled by a bleed valve 23. Downstream of the compressor 24 and bleed 26 is a variable geometry combustor 28 and a bypass passage 50. Respective first and second outlets 34, 53 of the compressor 24 provide air to the combustor 28 and bypass passage 50. In the combustor 28, compressed air from the compressor 24 is mixed with fuel and burnt to produce hot combustion gasses. The hot combustion gasses flow downstream to a variable geometry turbine 30. The hot gasses expand through and turn the turbine 30, which drives the compressor 24 via an interconnecting shaft 32. The engine compressor 24, combustor 28, and turbine 30 define a main fluid flow path.

An optional recuperator 35 is also provided. The recuperator 35 comprises a heat exchanger, for example in the form of a shell and tube heat exchanger. The recuperator 35 comprises a first inlet 37 which receives compressor delivery air from the compressor outlet 25, and a first outlet 39, which delivers heated compressor air to the combustor 18 inlet. The recuperator 35 further comprises a second inlet 41, which receives turbine exit air from the turbine 30, and a second outlet 43, which exhausts the cooled turbine exit air to atmosphere. Heat from the relatively hot turbine exit air is used to raise the temperature of relatively cool compressor air, prior to delivery to the combustor 18. Consequently, some of the exhaust heat is returned to the thermodynamic cycle of the engine 20, thereby increasing efficiency. The engine compressor

Both the compressor 24 and turbine 30 are variable geometry types, that is to say that the inlet and/or outlet areas of the compressor 24 and turbine 30 are adjustable to thereby control mass flow and/or pressure ratios across the compressor 24 and turbine 30 as engine rotational speed and compressor inlet conditions vary. The compressor 24 comprises a variable inlet guide vane 27 of conventional construction, which is configurable to different angles to thereby change the area of the inlet 22 of the compressor 24. The compressor 24 further comprises a variable diffuser vane 29 at an outlet 25 of the compressor, which is similarly configurable to different angles to thereby change the area of the outlet 25 of the compressor 24. The turbine 30 comprises a variable area nozzle guide vane 31 at an inlet 33 of the turbine 30, which is again configurable to different angles to thereby change the area of the inlet 33 of the turbine 30. Such structures may be similar to those described in U.S. Pat. Nos. 2,857,092 and 3,303,992, incorporated herein by reference. They will not be described in detail here. The turbine 30 is preferably of an axial flow configuration. A scroll is provided between the combustor 28 and turbine 30, which may impart a swirl to gases prior to entering the turbine 30.

An optional load in the form of an electrical generator 45 is provided. The electrical generator 45 in this embodiment is an alternating current (AC) electrical generator, which produces electrical power having a frequency dependent on the rotational speed of the generator. The generator 45 is coupled to the compressor 24 by the shaft 32. It is a requirement of many electrical loads (such as aircraft electrical loads) that the frequency of electrical power is maintained at a substantially constant value, within a margin of error.

FIG. 3 shows the variable geometry combustor 28 in more detail. The combustor 28 is in the form of a diffusion combustor, and comprises an inlet from which air from the first outlet 34 of the compressor 24 (either directly or indirectly via the recuperator 35) flows into the combustor 24. Downstream of the inlet is a main portion of the combustor comprising a “can” type combustor arrangement. The main portion of the combustor 28 comprises a generally cylindrical combustor casing 36 surrounding a combustor liner 38 (also known as a “flame tube”). In use, fuel is injected into the internal space defined by the combustor liner 38 by a fuel injector 40. Air is admitted into the internal space within the combustor liner 38 through a primary air inlet 42 surrounding the fuel injector 40, and through a first set of dilution holes 44 extending through a side wall of the combustor liner 38, which provides air from an annular space defined between the combustor casing 36 and liner 38. The area between the upstream end of the internal space within the combustor liner 38 and the first set of dilution holes 44 defines a primary combustion zone 46. The area within and downstream of the first set of dilution holes 44 defines a secondary combustion zone 48. Combustion takes place within the primary and secondary combustion zones 46, 48 as the air and fuel mix. Further air flowing through the annular space between the casing 36 and liner 38 provides cooling for the liner 38, and forms a non-combustion/cooling zone of the combustor 30. An endwall 39 is provided at a downstream end of the combustor casing 36. This seals the annular space between the casing 36 and liner 38, ensuring the air from the first compressor outlet 34 can only flow downstream from combustor casing 36 through the first set of dilution holes 44 and the primary air inlet 42 (i.e. into the first and secondary combustion zones 46, 48). Air can only enter the non-combustion zone through a bypass arrangement.

The bypass arrangement comprises a bypass conduit 50 and a bypass valve 52. An inlet 53 of the conduit 50 communicates with a second compressor outlet 53 upstream of the primary air inlet 42 of the combustor 28, and so the conduit 50 receives air from the compressor either directly or indirectly via the recuperator 35. An outlet 54 of the conduit 50 communicates with a pair of annular manifolds 55a, 55b, which surround the combustor liner 38, downstream of the endwall 39. A second set of dilution holes 56 extend through the liner 38 within the manifolds 55a, 55b, downstream of the first set of dilution holes 44. The conduit 50 is located entirely outside of the combustor 28, i.e. outside of the internal space defined by the combustor casing 36. Consequently, the bypass arrangement 50 provides air from the compressor directly to a downstream end of the combustor liner 38 (i.e. in the region of the second set of dilution holes 56), without extending through the combustion zones 46, 48.

The region of the combustor liner 38 within and downstream of the second set of combustor holes defines a non-combustion zone 58. Essentially no combustion takes place within the non-combustion zone 58, since the fuel introduced by the injector 40 has largely been burnt by this point.

The bypass valve 52 modulates mass flow of air through the bypass conduit 50, thereby controlling the ratio of air flowing through the combustion zones 46, 48 (and therefore air utilised in combustion) on the one hand, and air flowing through the bypass conduit 50 (and therefore not used in combustion) on the other. Consequently, the fuel/air ratio of air utilised in combustion can be controlled using the valve 52. For example, for a given mass airflow entering the combustor 18 from the compressor outlet 25, a higher fuel/air ratio can be provided by closing the valve 52, and a lower fuel/air ratio can be provided by opening the valve 52. In practice, it is desirable to maintain the fuel/air ratio at a constant value (generally slightly rich of stoichiometric) at changing mass air flows at the compressor outlet 25. Consequently, the present disclosure describes a gas turbine engine 20 and a method of operating the gas turbine engine 20 which allows changing mass airflows, and yet maintains the fuel/air ratio substantially constant.

The engine 20 comprises a controller 60 which is in signal communication with actuators for each of the compressor inlet guide vanes 27, diffuser vanes 29, combustor bypass valve 52 and turbine nozzle guide vanes 31. The controller 60 controls each of these actuators in accordance with a schedule on the basis of signals received from one or more of an inlet air mass flow (ω) sensing arrangement 54, an ambient temperature (T_{amb}) sensor 56 (in the form of a thermocouple for example), a compressor inlet temperature (T2) sensor 58, a compressor inlet pressure (P2) sensor 61, a combustor inlet temperature (T3) sensor 62, a combustor inlet pressure (P3) sensor 64, a fuel flow (WF) sensor 66, a turbine exit temperature (T5) sensor 68, a bleed air offtake sensor 69 for measuring mass flow through the bleed air offtake 26, and electrical generator rotational speed (N) and/or power sensor 71.

Referring to FIG. 4, the engine 20 is controlled by the controller 60 in accordance with a plurality of predetermined schedules. In use, gas turbine engine loads may vary. For example, increased electrical demand may result in more power being drawn by the generator 45, which would in turn increase the torque imposed by the generator 45 on the shaft 32, thereby reducing the rotational speed of the shaft 32, and the compressor 24 and turbine 30 coupled thereto. Similarly, bleed air demands from the bleed air port 26 may vary. Increased bleed air requirements will lead to a reduced compressor pressure ratio P3/P2, which will reduce airflow to the combustor 18, and may affect operability of the compressor 24. Alternatively, increased power could be selected by a user.

In a first step, a predetermined electrical generator rotational speed or electrical generator electrical frequency is determined. This may be fixed within the schedule, or may be varied in accordance with need. The current electrical generator rotational speed or electrical frequency is measured by the sensor 70, and compared to the predetermined value. If the predetermined and sensed values differ by more than a predetermined margin, a signal is sent to a fuel metering system (such as a variable capacity fuel pump or valve, not shown) to schedule an increased or reduced fuel flow to the fuel injector 40 of the combustor 18. Generally, where the electrical generator rotational speed or frequency falls below the predetermined value by more than the predetermined margin, fuel flow is increased. On the other hand, where the electrical generator rotational speed or frequency rises above the predetermined value by more than the predetermined margin, fuel flow is decreased. This fuel flow is sensed by fuel flow sensor 66, and a feedback loop is used to ensure that the scheduled fuel flow is met. The scheduled fuel flow may be determined by, for example, a PID controller, which measures electrical frequency, and adjusts fuel flow until the required electrical frequency is met.

In a second step (which may be carried out simultaneously with the first step), the compressor pressure ratio P3/P2 is controlled by the controller 60 by controlling the position of the variable inlet guide vanes 27 and diffuser guide vanes 29 to maintain the pressure ratio P3/P2 at a predetermined pressure ratio P3/P2_{target}. By varying vanes 27, 29 independently, both compressor pressure ratio P3/P2 and mass flow ω can be adjusted. The vanes 27, 29 are controlled by a PID controller to maintain measured P3/P2 at P3/P2_{target} to within an acceptable margin.

The predetermined pressure ratio P3/P2_{target} is determined by a compressor schedule in accordance with corrected speed N_{c}:

$${N}_{c} = \frac{N}{\sqrt{{T}_{amb}}}$$

The schedule comprises a table relating correct speed N_{c} with P3/P2 to generate a predetermined pressure ratio P3/P2_{target} for the measured corrected speed N_{c}. The corrected speed is in turn determined from signals provided by the speed sensor 70, and ambient temperature sensor 56.

In turn, the compressor schedule is determined by modelling and/or engine testing in accordance with several requirements.

Firstly, the requirements of the air supplied by the bleed air port 26 are taken into account. Generally, in order to function adequately, the components driven by the bleed air port 26 must receive bleed air having a minimum pressure Pₘᵢₙ, and a maximum temperature Tₘₐₓ. In turn, the minimum pressure Pₘᵢₙ could either be a predetermined fixed value, or could be scheduled on the basis of external conditions, such as aircraft speed, ambient temperature T_{amb}, and ambient pressure P_{amb}. For example, where the bleed air is to be used for main engine starting, the minimum pressure will generally vary in accordance with altitude (and therefore ambient pressure P_{amb}), as well as aircraft forward speed and ambient temperature T_{amb}. On the other hand, the maximum temperature Tₘₐₓ is generally a fixed value, and is determined by the maximum temperature that can be safely handled by the ducts, valves and components which receive the bleed air downstream. Consequently, the compressor schedule includes limits that ensure that the Tₘₐₓ and Pₘᵢₙ requirements are met at all times, or at least where the bleed valve 23 is open.

Secondly, compressor 24 efficiency is taken into account. The compressor 24 must be operated such that the compressor does not surge or stall during operation. In general, a “compressor map” can be identified for a given compressor arrangement. The compressor map relates compressor corrected speed N_{c} to compressor pressure ratio P3/P2. For a given corrected speed N_{c}, a surge line can be identified. The surge line is the maximum pressure ratio P3/P2 that can be maintained at the given corrected speed N_{c}. The schedule ensures that the compressor 24 operates below the surge line by operating the guide vanes 27, 29 to maintain the pressure ratio P3/P2 below the surge line.

Within the above requirements, the controller 61 generally controls the guide vanes 27, 29 to maintain the pressure ratio P3/P2 at the highest pressure ratio P3/P2 that can be maintained without exceeding the above limitations (i.e. without exceeding the surge line, or Tₘₐₓ, while maintaining Pₘᵢₙ). This ensures that, in general, the engine 20 is operated at maximum efficiency, since gas turbine thermodynamic efficiency is related to compressor pressure ratio P3/P2 (higher pressure ratios generally result in greater efficiency). However, in some operating conditions (such as at very high or very low corrected speeds), the compressor 24 may operate most efficiently at lower pressure ratios than the maximum that could meet the above requirements. For example, the maximum pressure ratio may entail operating the compressor 24 at very high speeds, which may be inefficient in view of aerodynamic and bearing losses. Consequently, the compressor schedule ensures that the most efficient pressure ratio P3/P2 is selected, while maintaining compressor operability and bleed air requirements. In consequence of the varying pressure ratio P3/P2, the massflow ω through the compressor also varies.

The controller 60 also controls other aspects of the engine 20 in accordance with further schedules. In a third step, the turbine capacity is adjusted.

In order to maintain efficiency, during steady state operation, the turbine exit temperature T5 is maintained in accordance with a steady state turbine schedule. The steady state turbine schedule comprises maintaining T5 at a target temperature T5_{target}. The current T5 is measured by temperature sensor 68, and the turbine nozzle guide vane 31 is controlled by the controller 60 to maintain the sensed temperature at the target temperature T5_{target}, again in accordance with a PID controller, implemented either in hardware or software.

In turn, the target temperature T5_{target} is determined in accordance with a T5 schedule. In general, during steady state operation, T5_{target} is maintained at a fixed value, which represents the maximum temperature that the turbine 30 can withstand without damage, while ensuring adequate life.

During transient operation (i.e. during acceleration or deceleration), the turbine nozzle guide vane 31 is controlled directly in accordance with a transient schedule, rather than on the basis of T5. In one example, the transient schedule comprises a lookup table correlating turbine nozzle guide vane 31 positions and demanded power levels. For example, a power level demand between 20% and 80% may correlate to operating the turbine nozzle guide vane 31 at a constant area. A power demand below 20% may correlate to operating the turbine nozzle guide vane at a smaller area, which falls further as power demand drops. A power demand above 80% may correlate to operating the turbine nozzle guide vane at a larger area, which rises further as power demand increases. Once the power level is met, as detected by the speed sensor 70, the controller 60 returns to operating the turbine nozzle guide vane 41 in accordance with the steady state schedule.

The transient turbine nozzle guide vane schedule also takes into account bleed flow from the bleed port 26, as determined by bleed flow sensor 59. The schedule includes a further lookup table relating bleed flows to a nozzle guide vane position delta. This delta is added to the position determined by the position determined by the power demand lookup table to determine the required nozzle guide vane 31 position. For example, where the bleed flow is relatively high the nozzle guide vane 31 area may need to be decreased to maintain efficient compressor operation.

In a fourth step, in order to maintain the combustor fuel/air ratio within predetermined limits (e.g. slightly rich of stoichiometric), the combustor bypass valve 52 is operated by the controller 60 in accordance with a bypass schedule. The bypass schedule comprises a lookup table relating a target corrected combustor combustion zone mass flow ω_{c} and possibly one or more other parameters. In one example, the scheduled target corrected mass flow ω_{c} is constant. In a further example, the corrected combustor mass flow ω_{c} is constant during steady state operation, but is scheduled to increase during acceleration, and decrease during deceleration.

Corrected mass flow ω_{c} is given by the relation:

$${ω}_{c} = ω \frac{ \sqrt{T}}{P}$$

Where, in this case, ω corresponds to combustor combustion zone mass flow, T corresponds to combustor entry temperature T3, and P corresponds to combustor entry pressure P3. P3 and T3 are directly measured by respective temperature and pressure sensors 62, 64, while combustor mass flow ω is measured by the mass flow sensing arrangement 64.

The mass flow sensing arrangement 64 could comprise logic within the controller 64 which relates sensed conditions with a lookup table, to calculate a combustor combustion zone mass flow ω. For example, compressor delivery mass flow could be calculated using sensed parameters such as fuel flow as sensed by the fuel flow (W_{F}) sensor 66 and compressor delivery temperature and pressure, as sensed by sensors 62, 64 respectively. Alternatively, compressor delivery mass flow could be determined from a heat balance or via the compressor map. Any compressor offtakes are subtracted from this calculated compressor delivery mass flow to generate a combustor delivery mass flow. For example, measurements from the bleed air offtake sensor 69 could be subtracted.

The controller 60 then controls the bypass control valve 52 to maintain the measured combustor combustion zone inlet mass flow ω_{c} at the target mass flow as determined by the schedule. The actual position of the bypass control valve 52 may be determined by pressure sensors (not shown) located upstream and downstream of the valve 52, to determine the pressure loss across the valve 52, and therefore the valve position. Again, this may comprise operating the valve 52 in accordance with a PID controller (either in hardware or software).

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

One or both of the recuperator and the bleed air port could be omitted. The gas turbine engine could be operated in accordance with a different control method.

For example, where the bleed air port is omitted, the compressor schedule could comprise operating the compressor only in response to compressor operability requirements. Similarly, the transient turbine nozzle guide vane position schedule would not include the bleed delta.

A further alternative control method might comprise a function optimisation algorithm, which would find a combination of control parameters (fuel flow, compressor inlet and diffuser guide vanes, combustor bypass valve position, turbine nozzle guide vane position) that would match minimum requirements (engine rotational speed, bleed air pressure, bleed air temperature, turbine inlet temperature T5, compressor surge margin), while optimising engine thermal efficiency.

The engine could be used to drive a different type of load. For example, the engine could be used to drive a load such as a constant pitch propeller, which does not require operation at a constant rotational speed. In such cases, the fuel flow could be modulated in accordance with a user input, such as a throttle. In general, higher power input requirements would require higher fuel flows, and vice versa. Advantageously, the control method enables efficient operation at a wide range of rotational speeds, allowing a simple fixed pitch propeller to be utilised.

Alternatively, the propeller could be variable pitch, in which rotational speed of the propeller (and therefore the engine) would be substantially fixed at different power levels. In this case, the engine would be controlled in a similar manner to that described in relation to the control method embodied in FIG. 4. In this case, the control method would be advantageous, since increased power levels could be provided at substantially fixed engine rotational speed. Consequently, power can be increased more rapidly, as there is no requirement to overcome the rotational inertia of the compressor, turbine and shaft.

Although the compressor variable inlet guide vanes and diffuser vanes are described as being operated together on the same schedule, they could be operated independently according to separate schedules on the basis of corrected rotational speed, or another suitable parameter. Fuel flow could alternatively be adjusted on the basis of a throttle input, instead of measuring a rotational speed for example.

Other details of the engine could be changed. For example, the variable geometry first compressor could comprise multiple centrifugal and/or axial stages, which could be coupled to one or more spools. The heat exchanger could alternatively comprise one or more regenerators. The turbine could be radial flow, and could comprise one or more stages, i.e. one or more pairs of rotors and stators. Alternatively, the turbine could be “statorless”, having successive counter rotating rotors. The load could be driven by a free power turbine, i.e. a turbine which is not coupled to an engine compressor.

The combustor could be of an annular or can-annular type. In an annular combustor, an annular combustor liner is provided, which is surrounded by an annular combustor casing. In a can-annular type, a plurality of cylindrical combustor liners are provided, which are all surrounded by a single annular combustor casing.

The outlet of the bypass arrangement could be different. For example, instead of providing air to a non-combustion zone of the combustor, the bypass air could be provided to a separate manifold, which receives air exiting the combustor. The separate manifold would be located upstream of the turbine nozzle guide vanes.

The method steps could be carried out in a different order. The apparatus could be carried out in accordance with a different method of operation.

Aspects of any of the embodiments of the invention could be combined with aspects of other embodiments, where appropriate. For example, the control methods described in relation to particular embodiments could be used in other embodiments.

1. A method of operating a gas turbine engine comprising a variable geometry compressor, a variable geometry combustor, and a variable geometry turbine, the method comprising:
operating the variable geometry combustor such that a corrected flow ω_{c} through a combustion zone of the combustor matches a predetermined value.

2. A method according to claim 1, wherein the method comprises varying fuel flow to the combustor such that a turbine rotational speed matches a predetermined value.

3. A method according to claim 2, wherein the predetermined turbine rotational speed comprises one of a fixed value and a value based on a required speed signal.

4. A method according to claim 1, wherein the method comprises varying the mass flow of the variable geometry compressor such that the compressor pressure ratio matches a predetermined value.

5. A method according to claim 4, wherein the predetermined pressure ratio is determined in accordance with a schedule of corrected compressor rotational speed.

6. A method according to claim 5, wherein the schedule of corrected compressor rotational speed is determined to obtain a maximum compressor ratio which results in stable compressor operation.

7. A method according to claim 5, wherein the schedule of corrected compressor rotational speed is determined to obtain a compressor ratio which results in both stable compressor operation and maximum compressor efficiency.

8. A method according to claim 5, wherein the schedule of corrected compressor rotational speed is determined to obtain at least a minimum bleed air pressure.

9. A method according to claim 1, wherein the method comprises operating the variable geometry first turbine such that the engine turbine inlet temperature matches a predetermined value.

10. A method according to claim 1, wherein the gas turbine engine comprises a combustor bypass passage having an inlet downstream of the engine compressor and upstream of the combustor inlet, and an outlet in fluid communication with a main fluid flow path downstream of a combustion zone of the combustor and upstream of an engine turbine inlet; wherein
the combustor bypass passage comprises a bypass control valve configured to selectively modulate the ratio of air flowing to the combustor inlet to air flowing through the bypass passage.
